(19) United States
(12) Patent Application Publication
(10) Pub. No.: US 2025/0344668 A1
(43) Pub. Date: Nov. 13, 2025

(54) ANIMAL CRATE WITH SMART TECHNOLOGY AND IMPROVED SAFETY FEATURES

(71) Applicant: Nicholas R. Jakel, Cedar Rapids, IA (US)

(72) Inventor: Nicholas R. Jakel, Cedar Rapids, IA (US)

(21) Appl. No.: 19/192,465

(22) Filed: Apr. 29, 2025

Related U.S. Application Data
(60) Provisional application No. 63/644,694, filed on May 9, 2024.

(51) Int. Cl. A01K 1/03; A01K 27/00; A61D 99/00

(52) U.S. Cl. CPC A01K 1/031; A61D 99/00; A01K 27/001

(57) ABSTRACT

The invention is a smart crate that includes a variety of improved features to promote safety and peace for both the pet and owner. Specifically, the disclosed crate includes smart technology with a remote monitoring system that allows a user to view, hear, and/or communicate with an animal positioned within the crate. Accordingly, pet and owner anxiety is thereby reduced or eliminated. The crate also includes improved safety features, such as an automatic locking element that allows a user to remotely open and close the crate door. In this way, the animal is allowed to exit the crate interior, such as in the case of an emergency.

### CROSS REFERENCE TO RELATED APPLICATIONS

This application claims priority to U.S. Provisional Patent Application Ser. No. 63/644,694 filed May 9, 2024, incorporated by reference herein.

### TECHNICAL FIELD

The presently disclosed subject matter is generally directed to an animal crate configured with smart technology and improved safety features. The presently disclosed subject matter also includes methods of making and using the improved animal crate.

### BACKGROUND

Dogs and other pets are commonly owned by families in the United States and worldwide. However, most families are unable to supervise pets at all times. As a result, pets are often left alone for several hours at a time. It is customary for owners to leave pets confined to a crate during unsupervised hours to prevent accidents to the home and injury to the pet. Conventional pet crates include a thin plastic or metal wire construction with an interior enclosure that includes a selectively openable door. However, prior art pet crates suffer from many disadvantages. For example, current crates lack safety features that are needed in emergency situations to allow the pet to exit the crate (such as a house fire). In addition, conventional pet crates are unequipped to allow an owner to communicate with the pet remotely in real time. As a result, pets often remain anxious or stressed while in the crate. Further, current pet crates offer no mechanism for an owner to view the pet in real time, remotely, while inside the crate. It would therefore be beneficial to provide an improved animal crate that overcomes the shortcomings of the prior art.

### SUMMARY

In some embodiments, the presently disclosed subject matter is directed to a smart animal crate. The term “smart” refers to a device that is capable of communicating with other devices, directly or indirectly, wirelessly, wired, etc., or by the Internet. Specifically, the crate comprises a housing for containing an animal, wherein the housing comprises a base, an opposed roof, and one or more sidewalls that extend between the base and the roof. The crate includes a door positioned in the one or more sidewalls, wherein the door is configured to be manually opened and closed or remotely opened and closed. In some embodiments, “remotely” refers to transmitting data characterizing the task to a remote environment (e.g., a cloud environment) over a communications network (e.g., the Internet), and receiving the results of the completed task back over the communications network.

The crate comprises a monitoring system comprising one or more sensors integrated within the housing and configured to generate sensor signals in response to the animal's behavior (e.g., sleeping, eating, taking a pill, sitting, standing, pacing, etc.), external and internal sounds (e.g., animal noises (e.g., barking, whining, growling, yelping), smoke detector alarms, doorbell sounds, thunder and other weather elements, banging, etc.), environmental conditions (e.g., temperature, loss of electricity), or both. The term “sensor” refers to an element that detects or measures a physical property and enables the recording, presentation or response to such detection or measurement using processor and optionally memory (e.g., a device and/or component that can receive input from physical stimulus and identify one or more physical properties). For example, a sensor can include a GPS component, a SLAM sensor, optical sensors (e.g., an optical distance sensor), a microphone, and/or a camera.

The crate further comprises a communications system coupled to the monitoring system, wherein the communications system is configured to monitor the sensor signals and based on the sensor signals, control the monitoring system to produce or change the environment in the housing, contact a registered user remotely via smart device, or both. The user is able to monitor the sensor signals from a remote location and change the environment in the housing on demand. A smart device is a device with processing capabilities. For example, the smart device can be a smart phone, a smart watch, a tablet, smart glasses, and the like.

In some embodiments, the monitoring system includes a feeding element and watering element, wherein the monitoring system detects a change in the amount of food present in the feeding element to trigger the addition of food to the food element and detects the amount of water present in the watering element to trigger the addition of water into the watering element. The feeding element can be a dispenser that distributes an amount of food to the interior of the crate (e.g., into a bowl). The watering element can be configured as a dispenser that distributes a volume of water into the interior of the crate (e.g., into a water bowl). The feeding element and watering element can be triggered by volume (e.g., after the animal eats or drinks) to replenish food or water, or can be triggered based on a set time (e.g., the animal is fed at 8:00 am and 4:00 pm).

In some embodiments, the feeding element and watering element are positioned on the door of the crate using a rail system. The rail system can include fixed and/or moveable rails mounted about the interior and/or exterior of the crate.

In some embodiments, the monitoring system includes an automatic pill or drug dispensing feature to dispense a pill or drug to the crate interior. For example, a volume of pills can be housed on a top surface (or any outer surface) of the crate and one pill (or a desired dose) is then inserted or deposited into the interior of the crate (e.g., via tubing or other pathway).

In some embodiments, the crate base includes a drainage feature (e.g., a grate or apertures in a bottom surface of the crate base).

In some embodiments, the door comprises a paddle latch that cooperates with a crate electronic strike plate to open the door manually and remotely. The strike plate is positioned on an interior sidewall of the crate, and wherein the strike plate includes a paddle latch contact in the area where the door paddle latch contacts the strike plate to lock the door in a closed position and retracts from the strike plate to unlock the door, and the door is configured to unlock and lock manually and remotely.

In some embodiments, the door includes one or more hinges that cooperate with a motor to electronically open the door on demand. The term “hinge” refers to a jointed or flexible device that connects and permits pivoting or turning of a part to a stationary component. Hinges include, but are not limited to, metal pivotable connectors, such as those used to fasten a door to frame, and living hinges.

In some embodiments, the door includes one or more spring loaded hinges that automatically open the door when the door is unlocked. The term “spring loaded” refers to any arrangement that utilizes a spring for connecting, securing, or attaching one or more objects to another object.

In some embodiments, the strike plate includes one or more deadbolt locks.

In some embodiments, the monitoring system includes one or more cameras, speakers, microphones, two-way speakers, and digital screens.

In some embodiments, the sensors are selected from one or more of noise detectors, motion detectors, temperature sensors, humidity sensors, smoke detectors, fire detectors, carbon monoxide detectors.

In some embodiments, the sensors are positioned on the animal in the form of a collar.

In some embodiments, the sensors are positioned on the interior of the crate, on a crate exterior surface, or both.

In some embodiments, the presently disclosed subject matter is directed to a method of adjusting an environment within the interior of the disclosed crate. Specifically, the method comprises sensing a trigger event by the monitoring system and adjusting the environment in the crate interior in response to the trigger event. The trigger event initiates communication of the trigger event remotely to a user. The environment within the interior of the crate is adjusted by the user remotely.

In some embodiments, the communication system further adjusts the environment within the crate automatically upon occurrence of the triggering event.

In some embodiments, the adjustment of the environment is selected from opening of the crate door, turning a fan on or off, turning a heating element on or off, initiating a feeding, initiating refill of a water bowl, dosing a medication, initiating video communication with a remote owner, initiating verbal communication with a remote owner, playing music, or combinations thereof.

### BRIEF DESCRIPTION OF THE DRAWINGS

FIGS. 1a and 1b are perspective views of smart crates with improved safety features in accordance with some embodiments of the presently disclosed subject matter.

FIG. 2 is a front plan view of a crate door in accordance with some embodiments of the presently disclosed subject matter.

FIG. 3 is a perspective view of a smart crate in accordance with some embodiments of the presently disclosed subject matter.

FIG. 4a is an exploded view of a smart crate in accordance with some embodiments of the presently disclosed subject matter.

FIG. 4b is an exploded view of a smart crate in accordance with some embodiments of the presently disclosed subject matter.

FIG. 4c is an exploded view of a smart crate in accordance with some embodiments of the presently disclosed subject matter.

FIG. 4d is a fragmentary perspective view of a smart crate handle in accordance with some embodiments of the presently disclosed subject matter.

FIG. 4e is a top plan view of a crate comprising handles in accordance with some embodiments of the presently disclosed subject matter.

FIG. 5 is a perspective view of a crate comprising an interior rail system in accordance with some embodiments of the presently disclosed subject matter.

FIG. 6a is a top plan view of a crate base comprising drainage holes in accordance with some embodiments of the presently disclosed subject matter.

FIG. 6b is a top plan view of a crate base comprising a drainage grid in accordance with some embodiments of the presently disclosed subject matter.

FIG. 6c is a fragmentary perspective view of a crate comprising a drain plug in accordance with some embodiments of the presently disclosed subject matter.

FIG. 7a is an interior side wall of the crate including strike plate in accordance with some embodiments of the presently disclosed subject matter.

FIG. 7b illustrates contact between a crate paddle latch and a strike plate in accordance with some embodiments of the presently disclosed subject matter.

FIG. 7c is a front plan view of a paddle latch in accordance with some embodiments of the presently disclosed subject matter.

FIG. 7d is a front plan view of a crate door in accordance with some embodiments of the presently disclosed subject matter.

FIG. 8 is a schematic of a crate monitoring system in accordance with some embodiments of the presently disclosed subject matter.

FIG. 9a is a cross-sectional view of a crate interior in accordance with some embodiments of the presently disclosed subject matter.

FIG. 9b is a perspective view of a crate in accordance with some embodiments of the presently disclosed subject matter.

FIG. 10a is an external view of a crate door in accordance with some embodiments of the presently disclosed subject matter.

FIG. 10b is an external view of the rear side of a crate in accordance with some embodiments of the presently disclosed subject matter.

FIG. 11a illustrates a crate fan in accordance with some embodiments of the presently disclosed subject matter.

FIG. 11b illustrates a crate heating element in accordance with some embodiments of the presently disclosed subject matter.

FIG. 12a is a schematic of a crate communications system in accordance with some embodiments of the presently disclosed subject matter.

FIG. 12b is a schematic of various features of a crate in accordance with some embodiments of the presently disclosed subject matter.

FIG. 13 is a perspective view of a crate in accordance with some embodiments of the presently disclosed subject matter.

### DETAILED DESCRIPTION

The presently disclosed subject matter is introduced with sufficient details to provide an understanding of one or more particular embodiments of broader inventive subject matters. The descriptions expound upon and exemplify features of those embodiments without limiting the inventive subject matters to the explicitly described embodiments and features. Considerations in view of these descriptions will likely give rise to additional and similar embodiments and features without departing from the scope of the presently disclosed subject matter.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” refer to “one or more” when used in the subject specification, including the claims. Thus, for example, reference to “a device” can include a plurality of such devices, and so forth. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise indicated, all numbers expressing quantities of components, conditions, and so forth used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, and/or percentage can encompass variations of, in some embodiments +/−20%, in some embodiments +/−10%, in some embodiments +/−5%, in some embodiments +/−1%, in some embodiments +/−0.5%, and in some embodiments +/−0.1%, from the specified amount, as such variations are appropriate in the disclosed packages and methods.

As used herein, the term “and/or” includes any and all combinations of one or more of the associated listed items.

Relative terms such as “below” or “above” or “upper” or “lower” or “horizontal” or “vertical” may be used herein to describe a relationship of one element, layer, or region to another element, layer, or region as illustrated in the drawing figures. It will be understood that these terms and those discussed above are intended to encompass different orientations of the device in addition to the orientation depicted in the drawing figures.

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

The presently disclosed subject matter is directed to an improved animal crate.

The term “animal” includes pets and companion animals, such as domestic cats and dogs, ferrets, rats, mice, rabbits, hamsters, gerbils, guinea pigs, reptiles, and birds. However, the term “animal” is not limited and can include any creature that can be housed within the disclosed crate. The term “crate” refers to an enclosure of any size or shape formed from a base and a plurality of panels. As discussed in detail below, the disclosed crate includes a variety of improved features to promote safety and enjoyment for both the pet and owner. For example, the disclosed crate includes smart technology with a remote monitoring system that allows a user to view, hear, and/or communicate with an animal positioned within the crate. Accordingly, pet and owner anxiety is thereby reduced or eliminated. The crate also includes improved safety features, such as an automatic locking element that allows a user to remotely open and close the crate door. In this way, the animal is allowed to exit the crate interior, such as in the case of an emergency.

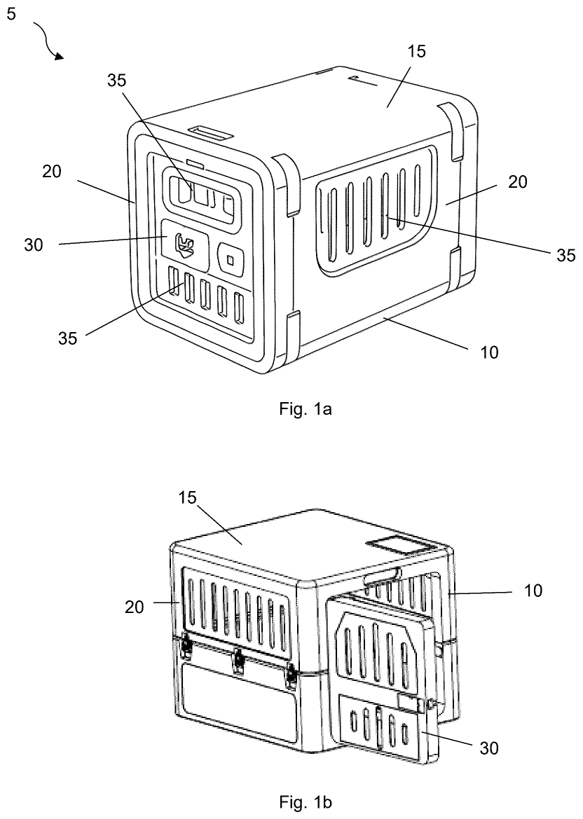

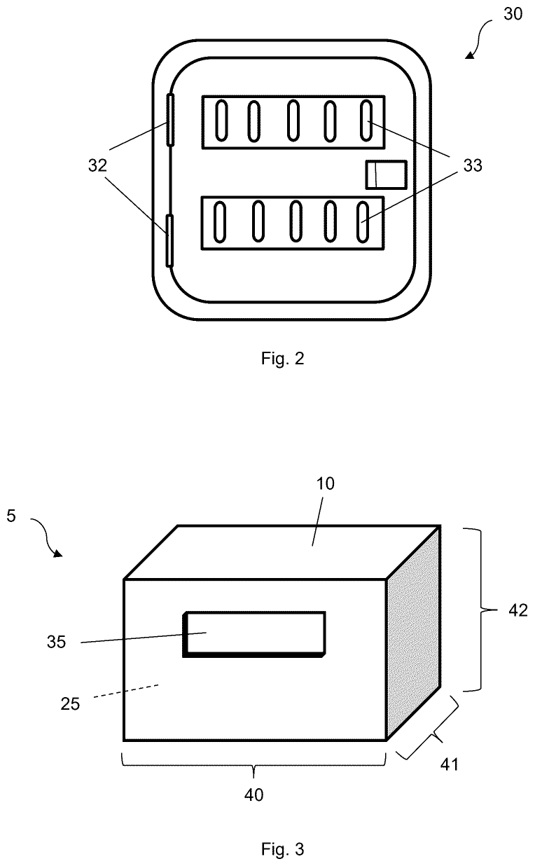

FIGS. 1a and 1b illustrate crate 5 comprising base 10 that rests on a support surface, such as the floor or the ground in some embodiments. The crate also includes opposed roof 15 (or top) and a series of sidewalls 20 that extend between the base and roof to create enclosed interior 25. One or more sidewalls 20 can include door 30 that provides an entrance and exit to the interior of the crate. Any type of door can be used, such as (but not limited to) bifold doors, swing doors, sliding door, pocket doors, French doors, barn doors, and the like. For example, door 30 can be configured as a swing door in some embodiments. The term “swing door” refers to a door that is opened and closed using a hinge. One example of a swing door is illustrated in FIG. 2, showing hinges 32 about which the door swings to open and close. The swing door can be spring-loaded or non-spring-loaded for ease of operability.

Door 30, roof 15, and/or sidewalls 20 can be constructed from solid material with no openings in some embodiments. In other embodiments, the material used to construct the door, roof, and/or sidewalls can be transparent or semi-transparent allowing the animal to see the environment external to the crate when the animal is within the crate interior. The term “transparent” refers to a characteristic of a material where an item positioned on one side of the material is visible from the opposite side of the material (e.g., a viewer can see the item through the material). The term “semi-transparent” refers to an intermediate state between transparent and opaque. In some embodiments, the door, roof, and/or sidewalls can include one or more vents 33 that allow for air flow and for the influx of light, as shown in FIG. 2. The vents are optional and can be configured as any type of opening in any desired size and shape.

One or more crate sidewalls 20 (and/or the door) can optionally include one or more windows 35, providing a way for an animal within crate interior 25 to view the environment outside of the crate. The term “window” includes any type of structural opening through a crate wall permitting air and/or light to enter the crate. Thus, window 35 allows a pet positioned within crate interior 25 to see the exterior environment (e.g., surrounding room). An owner can also visualize a pet within the crate via windows 35. Windows 35 optionally include one or more slits or other apertures that provide air flow. However, the slits are not large enough to allow the pet to escape from the interior of the crate. In some embodiments, the windows can be removed and exchanged for replacement windows or panels or shades to change the features and look of crate 5.

Crate 5 can be constructed from any suitable rigid material. The term “rigid material” refers to any non-elastic material. Suitable materials can include (but are not limited to) metal (e.g., stainless steel, steel, aluminum), wood, polymeric material (e.g., polyurethane, high density polyethylene, polypropylene), or combinations thereof. The materials used to construct the crate should include pet safe materials, to protect the animal in situations where the crate is licked or makes any contact with the animal. The term “pet safe” refers to the characteristic of being nontoxic and harmless to pets. Thus, a pet safe material will not cause any adverse reactions if an animal comes into contact with the material, licks it, inhales it, and/or ingests it.

Any method can be used to construct crate 5. In one representative (but not limiting example), rotational molding can be used to construct the crate frame (e.g., the roof, base, and sidewalls). Rotational molding involves a heated mold that is filled with a charge or shot weight of the material. The heated mold is then slowly rotated (usually around two perpendicular axes), causing the softened material to disperse and stick to the walls of the mold, thereby forming a hollow interior. To form an even thickness throughout the crate, the mold rotates at all times during the heating phase and the cooling phase to avoid sagging or deformation. It should be appreciated that the presently disclosed subject matter is not limited and any method can be used to construct the crate.

Crate 5 can also take any desired shape, such as rectangular, square, hexagonal, oval, and the like. Any shape can be used, and the crate is not limited to the shape illustrated in the drawings.

The disclosed crate can include any desired dimensions. As shown in FIG. 3, crate 5 can include length 40, width 41, and/or height 42 of about 10-100 inches (e.g., at least/no more than about 10, 20, 30, 40, 50, 60, 70, 80, 90, or 100 inches). The term “length” refers to the longest horizontal distance of the crate (e.g., between the two side edges). The term “width” refers to the longest straight-line distance perpendicular to the length of the crate (e.g., between the front and rear faces of the crate). The term “height” refers to the longest vertical distance of the crate (e.g., between base 10 and top side 15). It should be appreciated that the dimensions of the crate are not limited and, in some embodiments, can be configured larger or smaller than the ranges given above.

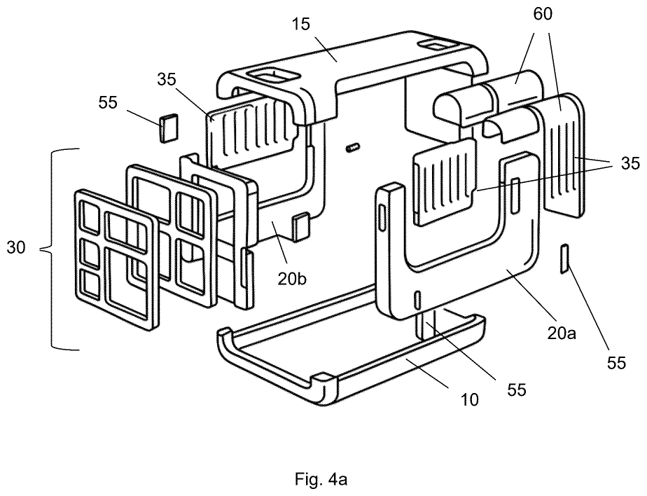

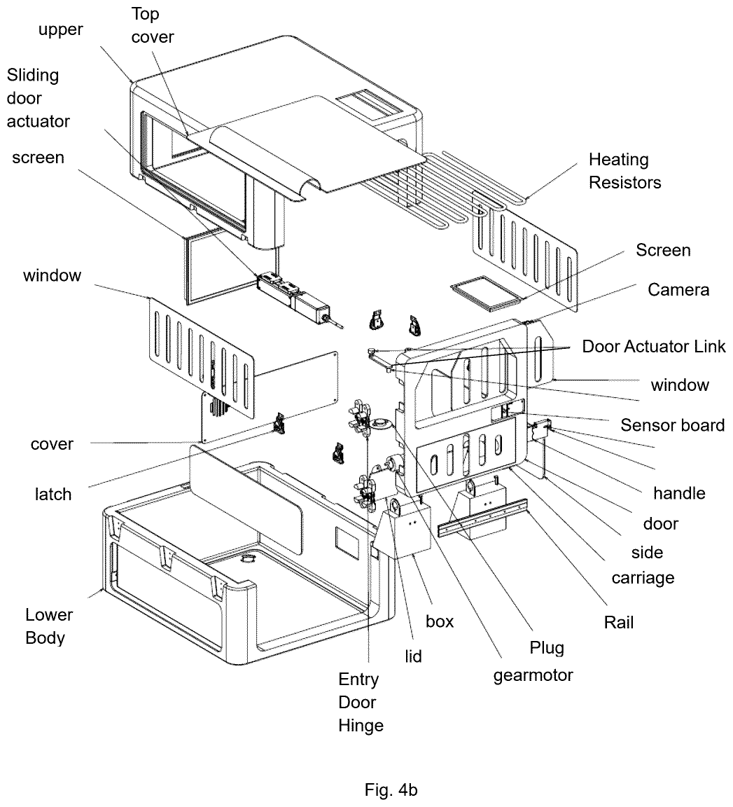

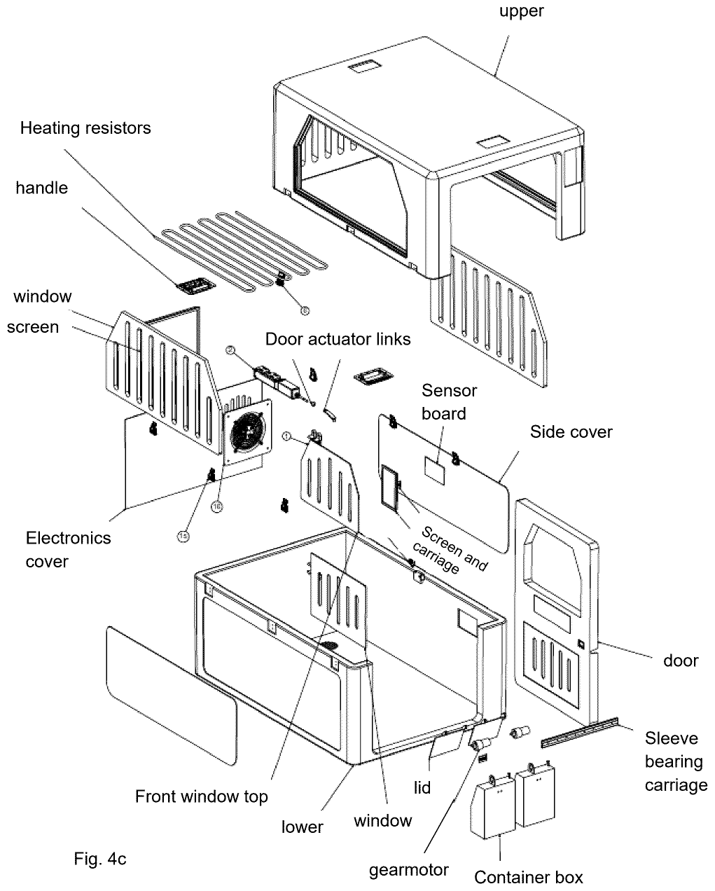

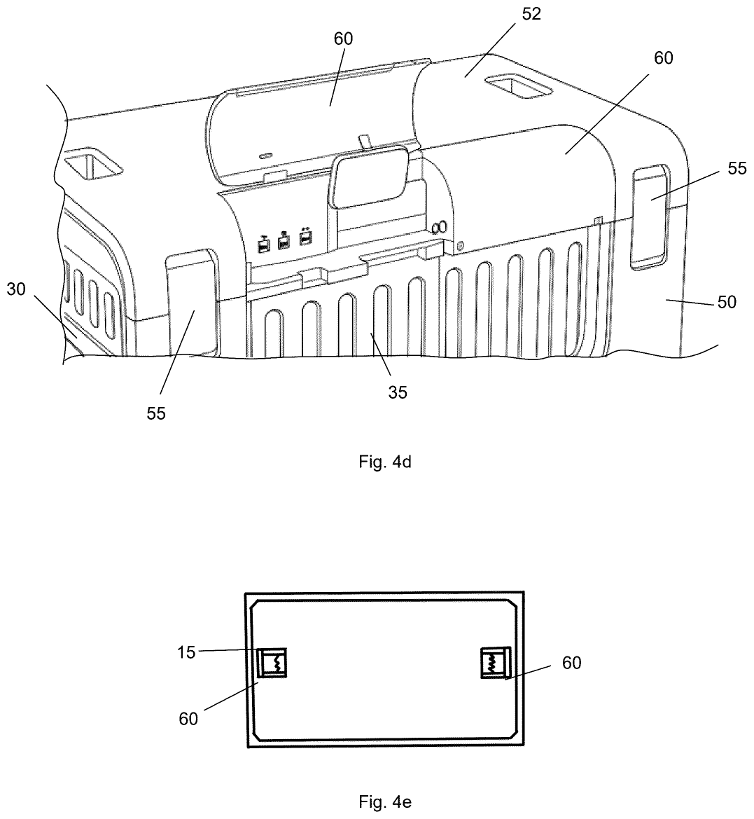

Advantageously, the crate can be easily and quickly assembled and disassembled, allowing a user to stow the crate when not needed. For example, the sidewall of crate 5 can be disassembled into two halves 20a and 20b, roof 15, and base 10, as shown in the exploded views of various embodiments illustrated in FIGS. 4a-4c. The components are pieced together in some embodiments using butterfly quick-release clamp locks 55, as illustrated in FIG. 4d. As shown, one or more handles 60 can be placed on the top side of the crate to ease mobility. Each handle can be spring-loaded so that when not in use it remains flush with the top side of crate 5. FIG. 4e illustrates roof 15 of the crate comprising integrated handles 60. The crate can therefore be easily and quickly assembled and disassembled without the use of tools, creating a time savings for users.

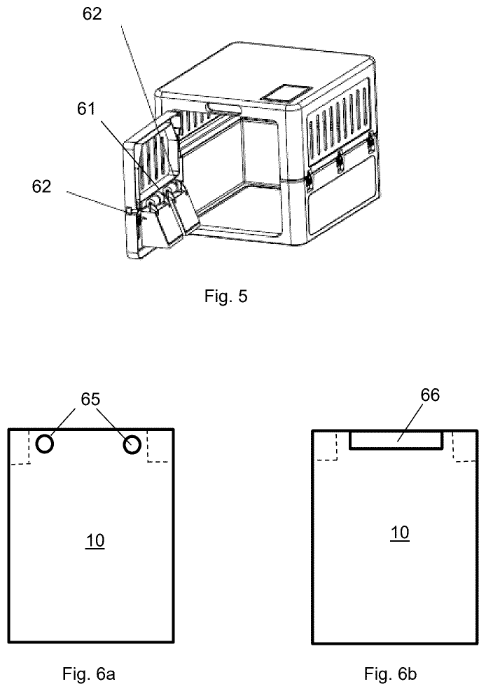

Optionally, the crate can include a feeding and/or watering system that provides food and water to an animal positioned within the interior of the crate. The feeding/watering system can be integrated with the frame of the crate. For example, food and/or water bowls can be positioned on the door of the crate using a rail system. In this way, the bowls can be easily slid on and off to replenish the food and water as needed. FIG. 5 illustrates one embodiment of crate 5 comprising one or more rails 61 that can be used to hold one or more containers 62, such as food, treats, etc. In use, an owner can fill the containers with food and then slide the container onto rail 62. The owner can remotely open the container so that the animal can access the container contents. In this way, an owner can feed the animal at the same time each day or give the animal a treat at any desired time.

As discussed in detail below, the food/watering system can be remotely controlled by the user and/or triggered using one or more sensors. For example, the bowl may be refilled with food at 6 pm each day. In another example, the water bowl is refilled when a sensor determines that the water level is below a set threshold (e.g., less than ⅓ full). In other embodiments, a sensor that determines the weight of the food bowl can be used to automatically refill the bowl when empty.

Crate 5 can also include an automatic pill or drug dispensing feature that can cooperate with the food dispensing feature and/or be independently operated. A desired pill or medication can be dispensed at a certain time each day to an animal within the crate interior or when remotely indicated by a user. Pill dispensing can occur similar to the rail system disclosed above. For example, a medication can be dispensed to the animal at a set time each day, or when remotely activated by a user.

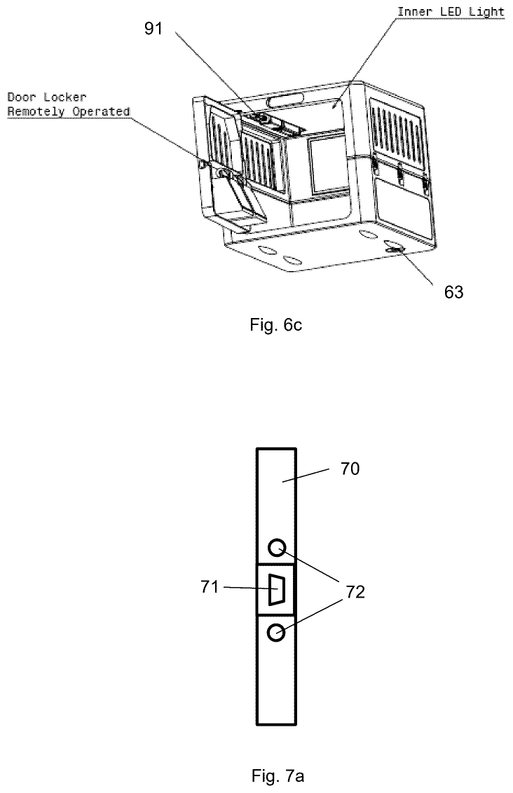

In some embodiments, base 10 of the crate can include a drainage feature that allows for the flow of liquid from the interior of the crate to the crate exterior (e.g., spilled water, urine, vomit). FIG. 6a illustrates drainage holes 65 positioned in base 10 that can be used to allow liquid to drain from the crate. In some embodiments, the drainage holes can be covered with removable plugs 63 or other closures to allow for selective use of the drainage feature, as shown in FIG. 6c. FIG. 6b illustrates open grid 66 positioned within the crate base that can the direct flow of liquid from the crate interior to a location exterior to the crate. The grid can include protective slats and the like to prevent injury to the animal. In this way, the base of the crate interior remains relatively dry, preventing messes and promoting cleanliness. The crate can include slats in the rear that can be opened to clean up any messes easily and effectively or wash out the crate interior.

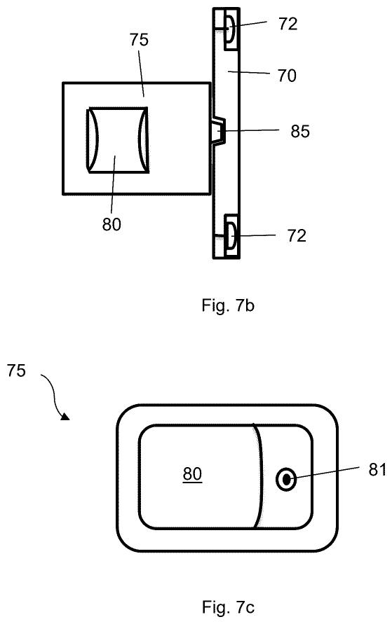

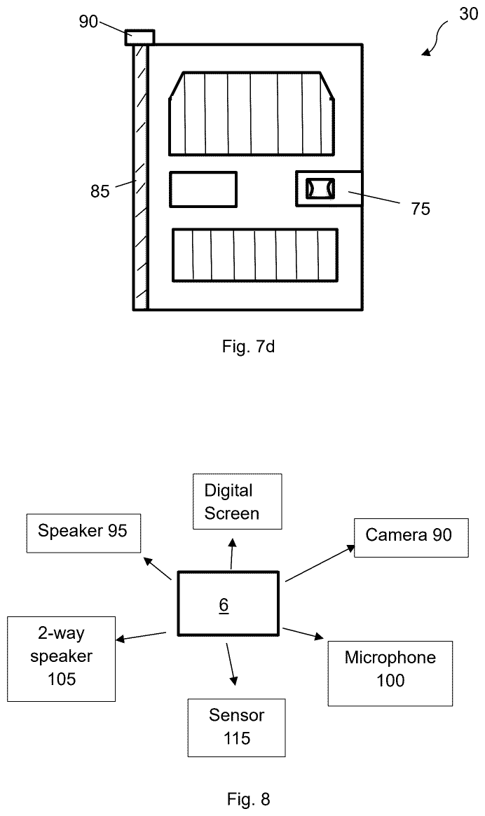

As mentioned above, crate 5 includes an automatic door opening feature that can be useful in case of an emergency. Specifically, crate 5 can include a smart door lock and paddle latch that enables a door of the crate to open and close on demand by an owner. FIG. 7a illustrates an interior side wall of the crate including strike plate 70 that cooperates with the door to open and close the crate. The strike plate includes paddle latch contact 71 in the area in which the door paddle latch 75 will contact the strike plate to lock into position when then the door is fully closed, as shown in FIG. 7b. The strike plate can also include electronic deadbolt integration 72 with the frame and door of the crate. As would be known in the art, a paddle latch is a recessed released handle that functions by pulling release mechanism 80. When the release mechanism is pulled, latch bar 85 is retracted from the paddle latch contact and the door can then be opened. The paddle latch is integrated into the door.

In some embodiments, the paddle latch can be key lockable to ensure that only authorized users can successfully open or close the crate. One representative example that includes keyhole 81 that cooperates with a key to lock and unlock the crate door is shown in FIG. 7c.

Opening and closing crate door 30 can be performed manually (e.g., when the user is at home) or remotely (e.g., when the user is away from crate 5). Thus, when a user is away, they can access strike plate 70 via a mobile application on a smart device. As the user activates the electronic strike plate remotely to remove the latch bar from the paddle latch contact, door 30 can then open. As illustrated in FIG. 7d, door 30 includes one or more hinges 85 that allow the door to swing open and closed. In some embodiments, motor 90 can be embedded into the frame of the crate adjacent to the door hinge 85. The door hinge is slid into the motor, allowing the user to remotely activate the motor to close or open the crate door. FIG. 6c illustrates actuator 91 that can be used to open the door in some embodiments. However, the presently disclosed subject matter also includes crates that have a motor built into the frame and configured to cooperate with the hinge of the door.

In some embodiments, hinge 85 can be a spring loaded hinge with a solenoid latch. A spring-loaded hinge aids in closing or opening as the door opens and closed. Specifically, an inner spring applies force to keep the hinge in a closed or open position. When a door attached to a spring-loaded hinge is unlocked as described above, the spring takes over and automatically opens the door without requiring manual intervention. The term “solenoid latch” refers to an electrically activated latch.

Thus, crate door 30 can be opened and/or closed manually by direct user contact (e.g., contacting the release mechanism to retract latch bar 85 and then manually opening the door). Alternatively, the door can be remotely opened or closed when the user is away by activating the electronic strike plate to unlock the door, and motor 90 to physically open the unlocked door. When spring-loaded hinges are used, as soon as the electronic strike plate is activated to unlock the door, the door automatically opens (e.g., no motor is required). Additionally, door release mechanisms can be used to open the door once it has been unlocked (e.g., the latch bar retracted). For example, opposing permanent or electromagnets on the frame housing and door have the ability to repel and push the door open with necessary force. Accordingly, door 30 can be opened remotely over a network or manually when the latching mechanism is opened and released.

Thus, in use, electronic strike plate 70 is paired with door paddle latch 75 to keep the door closed and secure. When a user desires to open the door remotely, the electric strike plate can be activated using a smart device (or physically opened if the user is with the crate). If there is a power outage to the crate, a manual override can be integrated into the locking system, allowing the paddle latch to function with and without power.

As noted above, the strike plate can include deadbolt 72, positioned adjacent to the paddle latch, thereby connecting the door with the crate frame. The deadbolt can be manual or electric. When the deadbolt is electric, it can be activated using a smart device as described herein to lock and unlock the door. Specifically, the deadbolt can be locked or unlocked when it receives a prompt via biometric sensor, Bluetooth®, Wi-Fi, or other wireless network protocols from a registered smart device (e.g., user's phone). The lock system can therefore use mobile apps or websites with a network-connected or Wi-Fi enabled lock. In use, a user can open or close the door of crate 5 no matter how far away they are. The electric deadbolt will remain open if power is lost to ensure the safety of the animal inside the crate.

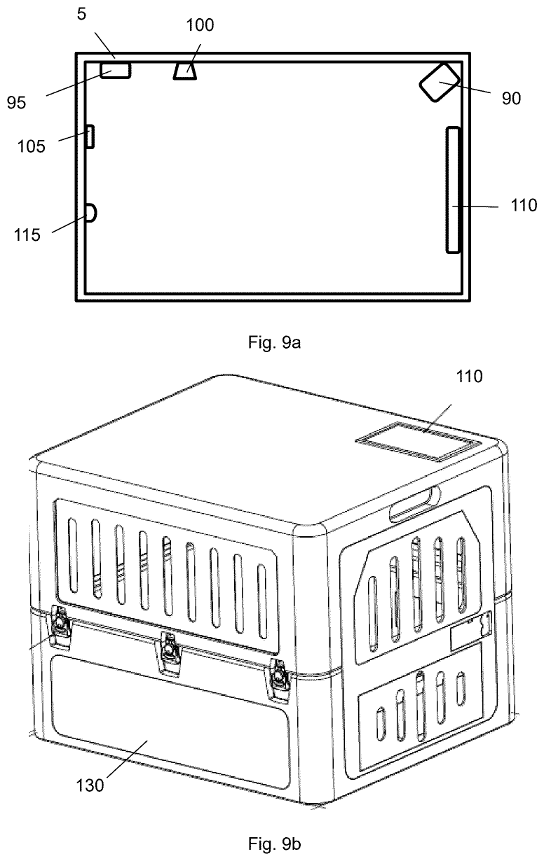

As also noted above, the disclosed crate can include monitoring system 6 that allows a user (e.g., pet owner) to view a pet housed within the crate interior. The monitoring system can include one or more multimedia interface devices to provide computer mediated communication between an animal inside the pet crate and a human, as shown in FIG. 8. For example, the system can include one or more cameras 90 and/or speakers 95 positioned on the crate interior and/or exterior, as shown in FIG. 9a. Optionally, the crate can also be configured with microphone 100 and/or two-way speaker 105 that allows the user to hear the pet and/or speak to the pet.

The term “camera” broadly refers to any image-capturing device that takes images of an environment and/or transmits/records video sequences of an environment. Camera 90 can be used to monitor and visually see the animal via a smartphone, computer, tablet, watch, etc. at any time or location within the crate interior. Any type of camera can be used, such as an HD camera. In some embodiments, camera 90 can indicate to the user the time of day (e.g., day or night) a particular image or video was captured.

The term “speaker” refers to any electro-acoustic device that converts electrical signals into sound. Speaker 95 can therefore include any type of speaker, such as electrodynamic speakers, loudspeakers, piezoelectric speakers, flat panel speakers, plasma arc speakers, coaxial speakers, cone speakers, dynamic speakers, and the like.

In use, the camera system will connect to a computing device located within the frame of the crate and connect to the network for the human user on the other end to see, in real-time, the animal (e.g., pet) in the crate. The camera can include recording and picture capabilities. In some embodiments, the camera can offer day/night visibility, including infrared visibility. Optionally, storage-based subscriptions may be available for the previous recording of footage on the camera, allowing for real-time and playback data features that can be viewed on the smart device application. Thus, crate 5 can provide computer-mediated communication between an animal inside the pet crate and a human. For example, a computing device (e.g., a mobile phone) configured by software may receive video, images, and/or sound data from a human and then transmit the data to the input/output subsystem of the crate via a network. A processor configured by software can process the received data and transmit the process data to the multimedia interface for display and/or playback. In the same way, the processor can be configured by software to enable the multimedia interface inside the crate interior to capture video, images, and/or sound data from an animal and transmit this data to the computing device for display and/or playback.

In some embodiments, the crate can include digital screen 110 within the crate interior to permit the animal to see the owner via the smart network connectivity, as shown in FIGS. 9a and 9b. The human can use the smart device application on one end and the image of the owner from the smart device camera will be displayed to the pet inside via the digital screen.

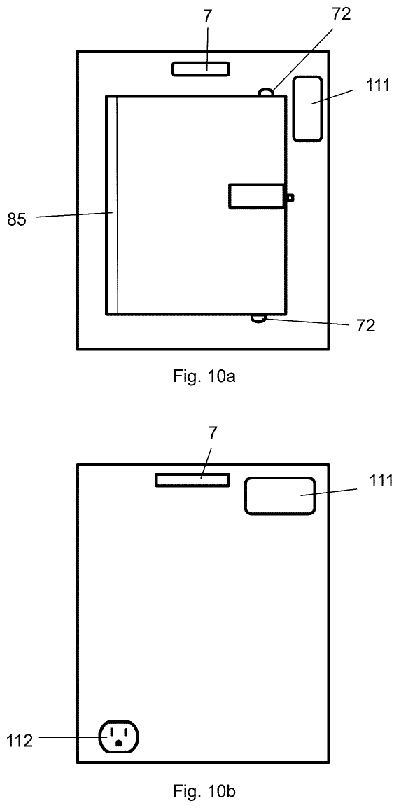

FIG. 10a illustrates an external view of the crate with both door 30 and frame included. In some embodiments, electric deadbolts 72 can be positioned on the top and/or bottom half of the crate (although the location of the deadbolts is not limited). FIG. 10b illustrates insert slots 7 for handles on the front and back side of the crate. It also shows an area in the upper right corner, for the placement of exterior digital screen 111. It should be appreciated that the location of screen 111 is not limited. The second screen can be used to connect the smart device application and show accessories such as time, connectivity, temperature, etc.

FIG. 10b illustrates the back side (e.g., rear) of the crate in some embodiments. At the top, insert 7 for a built in handle is shown adjacent to exterior digital screen 111 in the upper right corner. Again, the location of digital screen 111 is not limited. Power plug-in 112 can also be positioned on an exterior of the crate. The rear side of crate 5 can also optionally include a removable back to remove and insert a rechargeable battery pack that is integrated with the crate. The exterior digital screens 111 can display a variety of information to the user, such as time, temperature, Wi-Fi/Bluetooth® connectivity, battery level, etc.

In some embodiments, the system can include a noise decibel detection sensor (e.g., included as part of the microphone). The sensor can be configured to alert the owner via a smart device application that the sensor has been triggered by a loud noise, barking, etc. The application can connect the owner to the animal within the crate, allowing the owner to see the animal in real time, speak to the animal, to be visualized on the display, and/or open door 30. In this way, the owner can speak with the animal, send calming sounds to be played through speaker 95, etc.

Thus, crate 5 can include one or more sensors 115 configured to monitor the environment in and/or around the crate. The term “sensor” broadly refers to any implement that collects and/or produces information and/or data. For example, a sensor may be a position locating sensor such as a GPS device, a thermometer, smoke detector, clock, fire detector, motion detector, sound detector, humidity detector, carbon monoxide detector, and/or geo level indicator. For accuracy, all sensors can be calibrated against known standards. For example, in the case of a fire, sensor 115 can sense temperatures above a set threshold (e.g. room temperature). Once the temperature exceeds a set threshold level, the system can alert the pet owner of a potential emergency situation. In response, the owner can quickly drive home (if possible) and/or open the crate door remotely to free the pet from the crate. One or more sensors 115 can be positioned anywhere, such as within the crate interior, on an exterior surface of the crate, or both.

Thus, sensors 115 are used to detect aspects of the animal's environment to adjust the environment within the pet crate in response to the detected aspects. The conditioned environment within the pet crate will provide comfort to the animal, helping to reduce the animal's fear/anxiety. The crate may be communicatively coupled to a body sensor worn by the animal (e.g., a collar) and a computing device used by a human to form a pet care system, allowing for remote control of the pet crate and interaction with the animal.

In one example, if sensors 115 detect fire and/or smoke, an alarm signal will be triggered, automatically opening door 30 of the crate to free the animal. Optionally, an audible alarm can be triggered and help contacted (e.g., the owner, fire department, emergency contact). Thus, the integration of Wi-Fi calling and dialing system may be integrated into the crate, with a cellular backup for power failure. However, this feature can be turned off if desired and can be integrated into the home or building security system functionality.

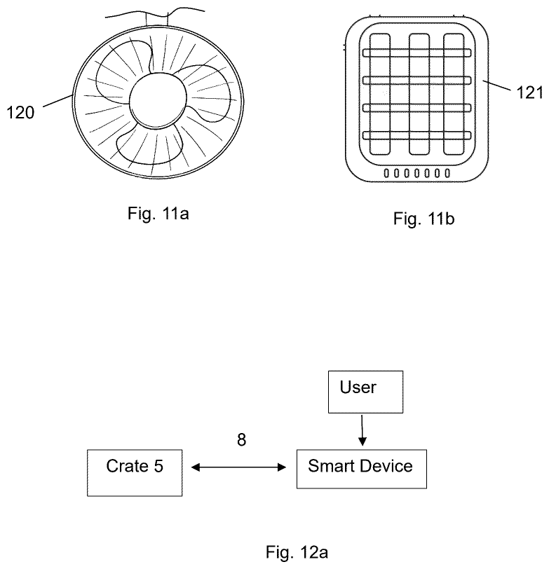

In some embodiments, a climate-controlled conditioning system can be integrated within the frame of the crate. The conditioning system allows the user the ability to adjust the temperature within/around crate 5 in the event of sudden changes in ambient temperature that may be dangerous to the animal. The conditioning system can include fan 120 to cool and/or move air to the crate or heating devices 121 (e.g., infrared heaters) to warm the crate, as shown in FIGS. 11a and 11b. In addition, safety devices are built into the system to ensure the temperature within the crate remains within certain parameters for the safety of the animal. The fans and heating devices can be automatically adjusted (e.g., turned on/off, rotated, speed increased/decreased, direction changed, etc.) based on a sensed temperature/humidity level or in response to a particular stimuli (e.g., a sensed time or animal behavior). Alternatively, the fans and/or heating devices may be manually adjusted via controls on the crate or through a computing device (e.g., a mobile phone).

Communication system 8 connects the human to the crate via a smart device application through WIFI and Bluetooth, as shown in FIGS. 11a and 11b. An electronic computer system is built into the framed enclosure of the crate and is connected to all the various electronic devices that make the crate intelligently smart and safe (e.g., smart phone, watch, computer, laptop, tablet). The electronic system includes a small-scale computer and operating system. The software on the computer is coded to connect the user on one end with a smart application to connect to the computer via Wi-Fi when away from crate 5, and Bluetooth® when near or without power. In the same system, the user is connected directly with the pet via the network interface between the user application computing device and the system hardware software and processor device.

The communications system (e.g., including an electronics board) may be mounted on the ceiling of the housing (or at any desired location on crate 5). The electronics subsystem can include one or more processors (e.g., microprocessor, controller, ASIC, etc.) to execute program code (e.g., software, firmware, etc.) stored in a nonvolatile computer readable storage device (i.e., memory) to enable the function of the pet crate. The memory (e.g., hard-drive, solid state drive) may also store files (e.g., audio files for playback, configuration settings, playlists, etc.) to facilitate the environmental conditioning. As noted above, the electronics subsystem is communicatively coupled to one or more sensors 115 that monitor the animal, the behavior of the animal, and/or the environment of the animal. For example, proximity sensors integrated with the interior of the crate may be used to produce sensor signals that correspond with a pet entering/exiting the crate or with a pet's presence in (or absence from) the crate. In other embodiments, the sensors can produce signals in response to (or corresponding with) light, temperature, humidity, or moisture (e.g., urine in the crate), and may also include a clock or timer to measure time of day and/or mark periods, events, or schedules. For example, sensor signals from a clock or timer may be used to control a food/water dispenser at particular feeding times.

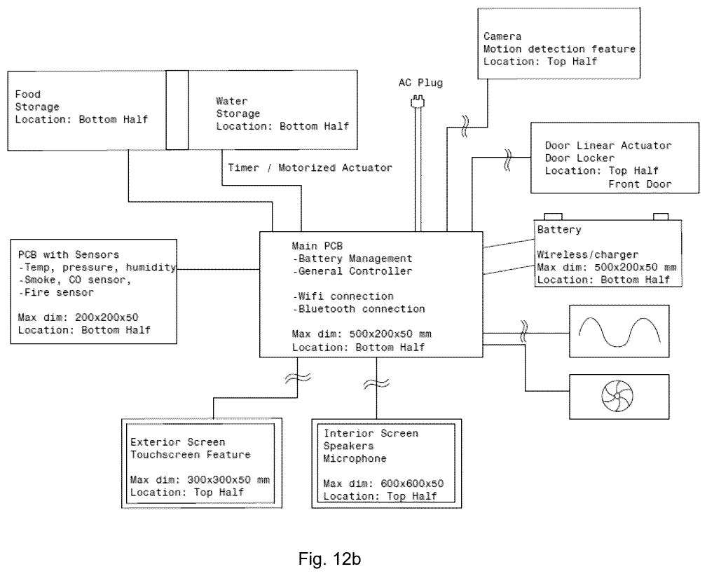

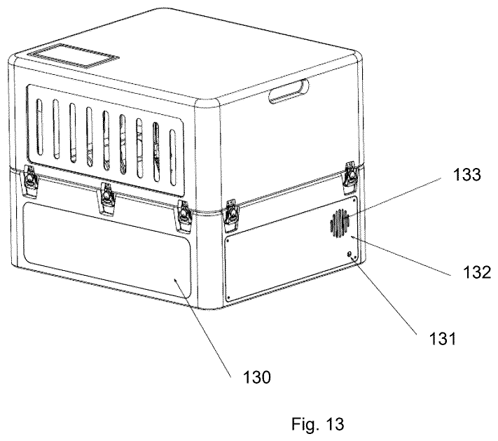

A processor receives the signals from the sensors and is configured by software to determine if active environmental conditioning is required and/or should be adjusted. In response to the sensor signals, the processor transmits signals to control an active environmental conditioning subsystem, such as speakers, lights, shades, fans, fragrance dispensers, food/water dispensers, music, door opening, and the like, as shown in FIGS. 12a and 12b.

A smart device application is designed to be used on Android® and IOS operating systems that are compatible with existing software. The application will be used to control the electronic features of the crate remotely via a smart device such as an iPhone® or Samsung Galaxy®. The application is designed to be paired with each crate with a multitude of user (pet) profiles with the ability to perform all necessary smart functions of the crate via the application.

The crate hardware operating system is configured to connect to a smartphone app to control all systems wirelessly. In this way, the owner can control the safety and interaction with a pet in or around crate 5. The crate is to be powered by a 120/220v outlet, along with a battery backup (optional) built into the structure of the crate.

The pet crate also includes a power subsystem for energizing the electronics and enabling function. The power subsystem may be attached to a power grid or may function from a battery. For example, a rechargeable battery may provide power when needed during a power outage or during travel. The battery may be built into the frame and/or detachable and can be charged wirelessly when either in or out of the frame. Thus, as shown in FIG. 13, the crate can include one or more wireless chargers 130, AC plug hole 131, electronics/PCB case (to be removable in some embodiments) 132, and ventilator 133. The battery can also be charged while stationed in the frame of the crate if the crate is plugged into a wall socket or a wireless charging station located on or near the charging point of the crate. If the battery pack is removed, a user may have the ability to charge elsewhere from the vicinity of the crate and place back when charged to satisfaction.

This system is coupled with a power source located within the frame/structure of the crate acting as a battery backup for all electronic systems. The crate can be plugged directly into a home power source and/or be reliant on the battery pack to run the smart and safe crate for a set amount of time. Charging from an auto power source such as a cigarette lighter outlet, USB, or similar ports is also contemplated with the crate. In the event of a power outage or if battery backup is dead, the electric deadbolt and electric strike plate may remain open and leave the door accessible via the manual lock. Alternatively, a manual locking mechanism may be integrated into or alongside the locking mechanism.

As noted above, crate 5 can be paired with a collar that tracks the pet. For example, the location of the pet can be tracked via the collar using conventional GPS location abilities. Further, the pet's heart rate, temperature, movement, and breathing rate can also be monitored and transmitted to the user via the smart device. In some embodiments, barking, growling, whining, yelping, or howling can also be detected. Accordingly, the health of the pet can be remotely monitored through the system by the owner. The pet crate may store this information in memory or transmit this information to the network or a computing device, as mentioned previously. Alternatively, the information communicated to the pet crate may be processed by the pet crate's processor control of the pet crate's environmental conditioners. For example, the communicated information may help to determine a dog's anxiety levels. The anxiety levels may, in turn, determine the type of environmental conditioning necessary, the duration of environmental conditioning, or the settings of a particular environmental conditioner.

Crate 5 offers many advantages over prior art crates. For example, crate 5 is easy to use, such that even children or the elderly can enjoy the system.

The crate can increase the safety of the pet by freeing the pet from the crate interior during an emergency situation. As noted above, in the case of severe weather, a fire, or other adverse condition, a user can remotely unlock the crate and open the crate door. In this way, the dog can escape to safety. It is estimated that over 40,000 domesticated animals, pets, die each year due to being locked in during a house fire. The owner can control the safety and interaction with the pet in or around the crate.

The crate can further reduce anxiety of the pet owner and pet. Owners often experience guilt when leaving a pet alone for extended periods of time. In addition, over 70% of all domesticated pets suffer from anxiety that can stem from sudden or loud noises, such as the garbage truck or simply being away from their owner. Many domesticated animals and their owners share a bond that can ease that anxiety. By accessing camera x and/or microphone x, the owner can alleviate anxiety and feel reassured that the pet is safe and happy.

Crate 5 can further alleviate anxiety in pets housed within the interior of the crate. Specifically, a pet experiencing anxiety may feel reassured if the owner accesses the communications system of the crate and speaks to the pet. The pet crate therefore provides a safe habitat for pets.

The crate is aesthetically appealing and is pleasant to look at.

Crate 5 functional and useful for all ‘smart’ features.

Exemplary embodiments of the methods and components of the presently disclosed subject matter have been described herein. As noted elsewhere, these embodiments have been described for illustrative purposes only, and are not limiting. Other embodiments are possible and are covered by the presently disclosed subject matter. Such embodiments will be apparent to persons skilled in the relevant art(s) based on the teachings contained herein. Thus, the breadth and scope of the present invention should not be limited by any of the above-described exemplary embodiments but should be defined only in accordance with the following claims and their equivalents.

What is claimed is:

1. A smart animal crate comprising:
a housing for containing an animal, wherein the housing comprises a base, an opposed roof, and one or more sidewalls that extend between the base and the roof;
a door positioned in the one or more sidewalls, wherein the door is configured to be manually opened and closed or remotely opened and closed;
a monitoring system comprising one or more sensors integrated within the housing and configured to generate sensor signals in response to the animal's behavior, environmental conditions, and sounds, or combinations thereof;
a communications system coupled to the monitoring system, wherein the communications system is configured to monitor the sensor signals and based on the sensor signals, control the monitoring system to produce or change the environment in the housing, contact a registered user remotely via smart device, or both;
wherein the registered user is able to monitor the sensor signals from a remote location and change the environment in the housing on demand;
wherein the user is able to control the smart functionalities of the smart edge remotely or physically, in which functions are operated by, but not limited to, the smart edge incorporated to tie in the miscellaneous smart features paired with the crate and its systems.

2. The crate of claim 1, wherein the monitoring system includes a feeding element and watering element, wherein the monitoring system detects a change in the amount of food present in the feeding element to trigger the addition of food to the food element and detects the amount of water present in the watering element to trigger the addition of water into the watering element.

3. The crate of claim 2, wherein the feeding element and watering element are positioned on the door or frame of the crate using a rail system.

4. The crate of claim 1, wherein the monitoring system includes an automatic pill/drug or reward dispensing feature to dispense a pill or drug to the crate interior.

5. The crate of claim 1, wherein the crate base includes a drainage feature.

6. The crate of claim 1, wherein the door comprises a paddle latch that cooperates with a crate electronic strike plate and actuator to open the door manually and remotely;
wherein the strike plate is positioned on an interior sidewall of the crate, and wherein the strike plate includes a paddle latch contact in the area where the door paddle latch contacts the strike plate to lock the door in a closed position and retracts from the strike plate to unlock the door;
and wherein the door is configured to unlock and lock manually and remotely.

7. The crate of claim 6, wherein the door includes one or more hinges that cooperate with a motor to electronically open the door on demand.

8. The crate of claim 6, wherein the door includes one or more spring loaded hinges that automatically open the door when the door is unlocked.

9. The crate of claim 6, wherein the strike plate includes one or more deadbolt locks.

10. The crate of claim 1, wherein the monitoring system includes one or more cameras, speakers, microphones, two-way speakers, and digital screens.

11. The crate of claim 1, wherein the sensors are selected from one or more of noise detectors, motion detectors, temperature sensors, humidity sensors, smoke detectors, fire detectors, carbon monoxide detectors.

12. The crate of claim 1, wherein the sensor is positioned on the animal in the form of a collar.

13. The crate of claim 1, wherein the sensor is positioned on the interior of the crate, on a crate exterior surface, or both.

14. A method of adjusting an environment within the interior of the crate of claim 1, the method comprising:
sensing a trigger event by the monitoring system;
adjusting the environment in the crate interior in response to the trigger event;
wherein the trigger event initiates a communication of the trigger event remotely to a user;
whereby the environment within the interior of the crate is adjusted by the user remotely.

15. The method of claim 14, wherein the communication system further adjusts the environment within the crate automatically upon an occurrence of the triggering event.

16. The method of claim 14, wherein the adjustment of the environment is selected from opening of the crate door, turning a fan on or off, turning a heating element on or off, initiating a feeding, initiating refill of a water bowl, dosing a medication, initiating a reward, initiating video communication with a remote owner, initiating verbal communication with a remote owner, playing music, or combinations thereof.

17. The method of claim 14, wherein the door comprises a paddle latch that cooperates with a crate electronic strike plate to open the door manually and remotely;
wherein the strike plate is positioned on an interior sidewall of the crate, and wherein the strike plate includes a paddle latch contact in the area where the door paddle latch contacts the strike plate to lock the door in a closed position and retracts from the strike plate to unlock the door;
and wherein the door is configured to unlock and lock manually and remotely.

18. The method of claim 14, wherein the monitoring system includes one or more cameras, speakers, microphones, two-way speakers, and digital screens.

19. The method of claim 14, wherein the sensors are selected from one or more of noise detectors, motion detectors, temperature sensors, humidity sensors, smoke detectors, fire detectors, carbon monoxide detectors.

20. The method of claim 14, wherein the door includes one or more hinges that cooperate with a motor to electronically open the door on demand.
